(19) United States
(12) Patent Application Publication
(10) Pub. No.: US 2005/0205350 A1
(43) Pub. Date: Sep. 22, 2005

(54) [SPEAKER MODULE FRAME, SPEAKER MODULE THEREWITH, AND ELECTRONIC DEVICE WITH SPEAKER MODULE]

(76) Inventor: Bill Yang, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/709,468

(22) Filed: May 7, 2004

(30) Foreign Application Priority Data
Mar. 18, 2004 (TW) 93107218

(51) Int. Cl. H04R 19/04; H04R 21/02

(52) U.S. Cl. 181/160; 181/171

(57) ABSTRACT

An electronic device is provided. The electronic device at least comprises a speaker module. The speaker module includes: a speaker module frame having an accommodating hole; a microspeaker accommodated in the accommodating hole; a front cover disposed at a first side of the speaker module frame, a front sound enclosure being formed between the front cover and the speaker module frame, the front cover having a plurality of tone holes; a rear cover disposed at a second side of the speaker module frame, the second side being opposite to the first side, a rear sound enclosure being formed between the rear cover and the speaker module frame.

### CROSS REFERENCE TO RELATED APPLICATIONS

This application claims the priority benefit of Taiwan application serial no. 93107218, filed on Mar. 18, 2004.

### BACKGROUND OF INVENTION

1. Field of the Invention

This invention generally relates to a speaker module and a speaker module frame, and more particularly to a speaker module frame, a speaker module, and a electronic device with the speaker module for improving the sound quality.

2. Description of Related Art

In the modern era, people rely heavily on the electronic products. For example, mobile phones, computers, audio-video products are ubiquitous. I.e., the electronic products are almost indispensable for our daily life. As the electronic technology advances, the new electronic products with more personalized functions have been developed. Among those electronic products, the mobile phones are prevailing because of the advancement of the communication technology. Almost everyone in the urban areas owns a mobile phone.

As for the mobile phone, the developers have been tried to reduce the weight and the size of the mobile phones so that it can be portable. Further, the developers have also tried to increase the functions and reduce the radiation of the mobile phones. The compact size of the mobile phone is the trend for those developers. However, the elements in the mobile phone are arranged in a manner to reduce the size of the mobile phone. As for the speaker, as the size of the mobile phone gets smaller and smaller, most mobile phone designers are unaware of the advantage of the space in front of and behind the speaker to acquire the better sound quality. Due to the worse design of the sound box, the sound quality is affected seriously. Therefore, how to provide the proper space in front of and behind the speaker to acquire the better sound quality for mobile phone, PDA, smart telephone, or the other handheld electronic devices is an important issue.

FIG. 1 is a cross-sectional view of a portion of a conventional microspeaker in a handheld electronic device. Referring to FIG. 1, the conventional microspeaker 100 is disposed inside the handheld electronic device 10. The case 10 in front of the microspeaker 100 has a plurality of tone holes 12 so that the sound made by the microspeaker 100 can be outputted through the tone holes 12. To provide the front sound enclosure, the case 10 for disposing the microspeaker 100 has the protruding frame 14. Traditionally, the microspeaker 100 is attached on the protruding frame 14 via the sealing rubber 20. To provide the better sound quality by the microspeaker 100, the space of the front sound enclosure depends on the height h of the protruding frame 14 and the area A of the microspeaker 100. For example, if the microspeaker 100 requires the front sound enclosure with 300 cm³, the multiplication of the area A of the microspeaker 100 the height h of the protruding frame 14 (i.e. A*h) has to be larger than 300 cm³.

However, to follow the trend toward the compact size of the handheld electronic devices, the manufactures will makes the microspeaker 100 much closer to the case 10, which would significantly reduce the space of the front sound enclosure and thus the sound quality of the microspeaker 100 is being sacrificed. In addition, the microspeaker 100 is attached on the protruding frame 14. In the handheld electronic device with a compact size, most circuits are disposed in a very limited space, which affects the resonance of sound enclosure of the microspeaker 100 because there is no space around the microspeaker 100 for resonance.

Therefore, even if the microspeaker 100 has no sound quality issue when tested, when it is installed into the handheld electronic device, the sound quality of the microspeaker 100 will significantly deteriorate due to the improper space arrangement.

### SUMMARY OF INVENTION

The present invention is directed to a speaker module with the built-in front sound enclosure and rear sound enclosure for the clients convenience so that the client can install it into the electronic device without considering the space arrangement.

The present invention is directed to an electronic device for improving the sound quality of the speaker module of the electronic device.

According to an embodiment of the present invention, a speaker module frame, suitable for disposing a microspeaker therein is provided. The speaker module frame comprises a main portion having an accommodating hole for accommodating the microspeaker; and an extending portion, extending from a side of the main portion to form a fixed resonance space for the microspeaker.

According to an embodiment of the present invention, a speaker module and an electronic device with the speaker module are provided. The speaker module includes a speaker module frame having an accommodating hole; a microspeaker accommodated in the accommodating hole; a front cover disposed at a first side of the speaker module frame, a front sound enclosure being formed between the front cover and the speaker module frame, the front cover having a plurality of tone holes; a rear cover disposed at a second side of the speaker module frame, the second side being opposite to the first side, a rear sound enclosure being formed between the rear cover and the speaker module frame.

In an embodiment of the present invention, the area of the speaker module frame facing the front sound enclosure is larger than the area of the microspeaker. The speaker module frame includes a plurality of positioning slices extending from a sidewall of the accommodating hole to a center of the accommodating hole for positioning the microspeaker.

In an embodiment of the present invention, the microspeaker includes a speaker vibration system and a magnetic loop; the speaker vibration system is a vibration film having a coil.

In light of the above, the frame of speaker module, the speaker module therewith, and the electronic device with the speaker module of the present invention use the extending wall of the frame of the speaker module to form a resonance space in front of the microspeaker. Hence, the present invention can make sure there is a sufficient resonance space when the microspeaker is installed in the electronic device so that the microspeaker can provide a good sound quality.

The above is a brief description of some deficiencies in the prior art and advantages of the present invention. Other features, advantages and embodiments of the invention will be apparent to those skilled in the art from the following description, accompanying drawings and appended claims.

### BRIEF DESCRIPTION OF DRAWINGS

FIG. 1 is a cross-sectional view of a portion of a conventional microspeaker in a handheld electronic device.

FIG. 2A is a top view of the frame of the speaker module in accordance with an embodiment of the present invention.

FIG. 2B is a bottom view of the frame of the speaker module of FIG. 2A.

FIG. 2C is a side view of the speaker module using the frame of FIG. 2A.

FIG. 2D is a front view of the speaker module using the frame of FIG. 2A and the microspeaker.

FIG. 3 is a cross-sectional view of the electronic device in accordance with anembodiment of the present invention.

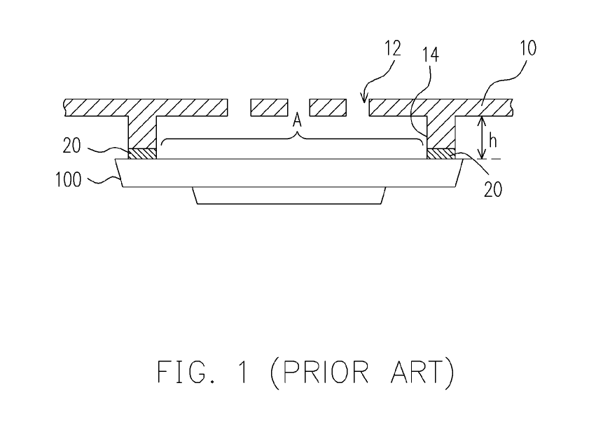

### DETAILED DESCRIPTION

The present invention provides a speaker module with the built-in front sound enclosure and rear sound enclosure for the clients convenience so that the client can directly install it into the electronic device without considering the space arrangement.

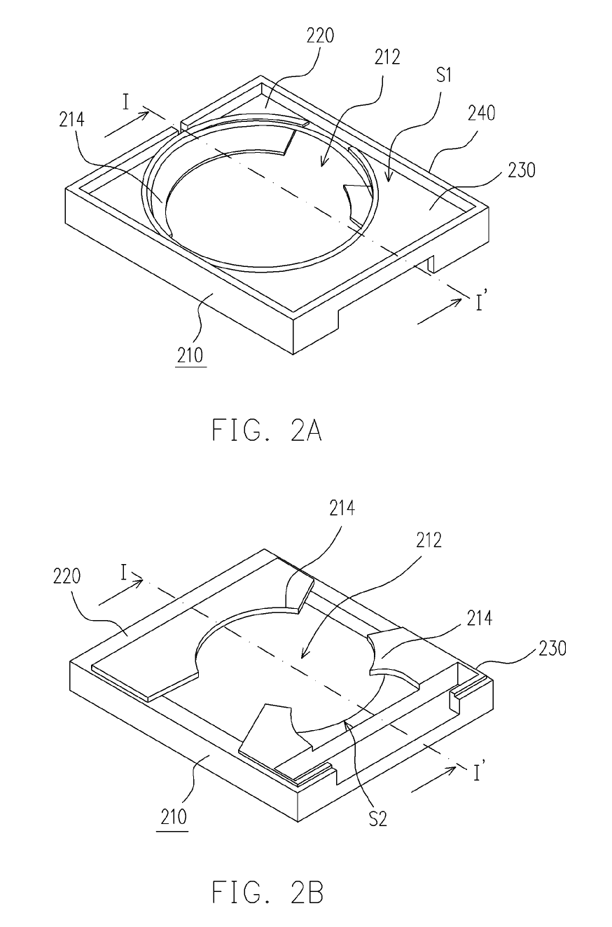

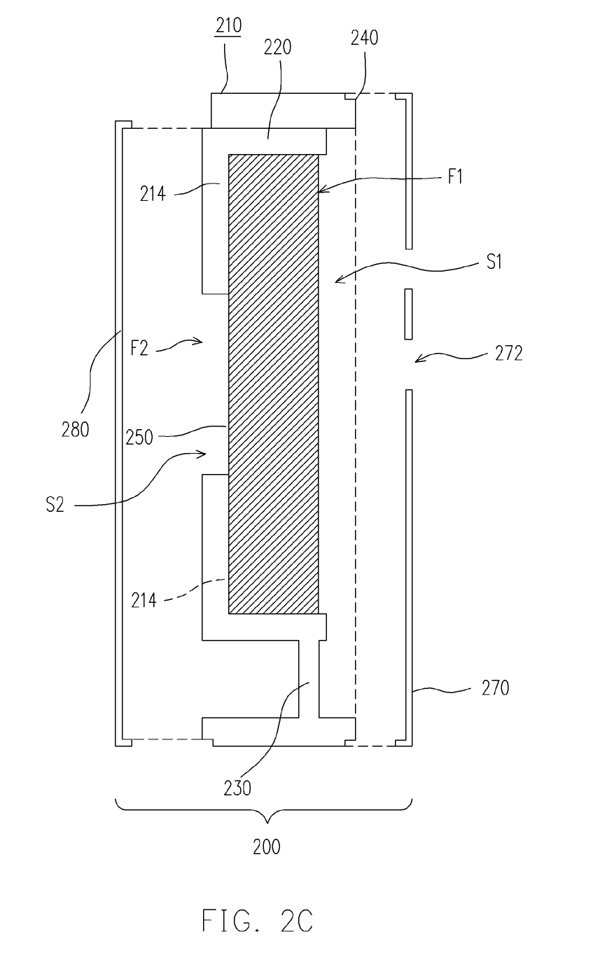

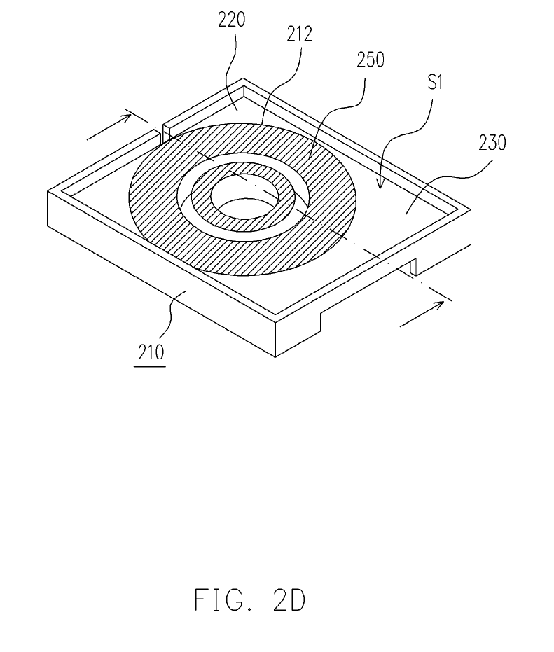

FIG. 2A is a top view of the frame of the speaker module in accordance with an embodiment of the present invention. FIG. 2B is a bottom view of the frame of the speaker module of FIG. 2A. FIG. 2C is a side view of the speaker module using the frame of FIG. 2A. FIG. 2D is a front view of the speaker module using the frame of FIG. 2A and the microspeaker.

Referring to FIGS. 2A-2D, the speaker module 200 includes a speaker module frame 210. The speaker module frame 210 is a one piece structure formed by plastic injection molding. The speaker module frame 210 includes a main portion 220 having an accommodating hole and an extending portion 230. In an embodiment, the shape of the speaker module frame 210 can be a rectangle; the accommodating hole 212 for accommodating a microspeaker 250 is formed by scooping a hole in the main portion 220. The microspeaker 250 includes a speaker vibration system and a magnetic loop. The speaker vibration system is a vibration film with a coil. The extending portion 230 extends from a side of the main portion 220. There is a protruding portion 240 around the main portion 220 and the extending portion 230. The protruding portion 240 encloses a resonance space S1. The resonance space S1 is in front of the accommodating hole 212. Therefore, when the microspeaker 250 is installed in the accommodating hole 212, there is a resonance space S1 in front of the microspeaker 250. The resonance space S1 can be the front sound enclosure of the microspeaker 250. The size of the resonance space S1 will affect the performance of the speaker module 200. Hence, the height of the protruding portion 240 depends on the characteristics of the microspeaker 250 in order to provide the best front sound enclosure.

In addition, the total area of the main portion 220 and the extending portion 230 is larger than the area of the microspeaker 250 so as to obtain a larger resonance space S1. This is because the sound wave generated by the microspeaker 250 has a larger area. For a fixed space requirement, if the total area of the main portion 220 and the extending portion 230 is larger, the required height of the protruding portion 240 can be reduced. I.e., the thickness of the speaker module 200 can be reduced in order to follow the trend of compact size for the handheld electronic device.

The main portion 220 of the speaker module frame 210 also includes a plurality of positioning slices 214 extending from a sidewall of the accommodating hole 212 to a center of the accommodating hole 212 for positioning the microspeaker 250. They also provide the support for the backside F2 of the microspeaker 250 to prevent the microspeaker 250 from being out of the accommodating hole 212. In addition, the space between each positioning slice 214 can form a resonance space S2. The resonance space S2 can be the rear sound enclosure for the microspeaker 250. The size of the resonance space S2 depends on the characteristics of the microspeaker 250 in order to provide the best front sound enclosure.

Referring to FIG. 2C, the speaker module 200 includes the above speaker frame 210, the microspeaker 250, the front cover 270, and the rear cover 280. The microspeaker 250 is disposed in the accommodating hole 212; the microspeaker 250 has a sound side F1 and a backside F2. The front cover 270 is located in front of the resonance space S1 of the speaker module frame 210 such as being attached at the top of the protruding portion 240. The front cover 270 is to prevent the microspeaker 250 from being out of the speaker module 210. The front cover has a plurality of tone holes 272. The tone holes 272 are located in front of the accommodating hole 212. I.e., when the speaker module is assembled, the sound generated by the microspeaker 250 can pass through the tone holes 272 on the front cover 270 to the outside. In addition, another important purpose of the front cover 270 is to form the resonance space S1 as the front sound enclosure for the microspeaker 250. This arrangement is to prevent the other elements from affecting the resonance space S1 after the speaker module 200 is installed in the electronic device.

In addition, the sound side F2 of the microspeaker 250 includes a rear cover 280 fixed on the speaker module frame 210 in order to form the resonance space S2. The resonance space S2 can be the rear sound enclosure of the microspeaker 250. The speaker module frame 210, the front cover 270, and the rear cover 280 are fixed together to be the speaker module 200. This speaker module 200 includes the built-in front sound enclosure and rear sound enclosure for the clients convenience so that the user can install it into the electronic device without considering the space arrangement. FIG. 2D is a front view of the speaker module using the frame 210 of FIG. 2A and the microspeaker 250.

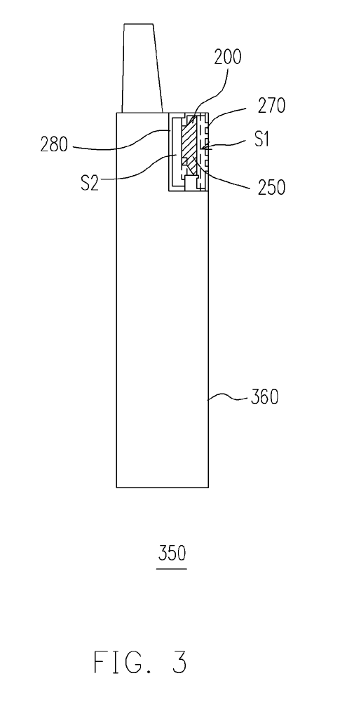

FIG. 3 is a cross-sectional view of the electronic device in accordance with an embodiment of the present invention. Referring to FIGS. 2C and 3, the electronic device 350 uses the speaker module 200 of FIG. 2C. The electronic device 350 can be the mobile phone, PDA, smart telephone, or the other handheld electronic devices. The speaker module 200 includes the above speaker frame 210, the microspeaker 250, the front cover 270, and the rear cover 280, and is disposed in the case 360 of the electronic device 350. Because there are reserved spaces inside the speaker module 200 for resonance, i.e., the built-in front sound enclosure and rear sound enclosure, the electronic device 350 with the speaker module 200 can provide an excellent sound quality and volume without being affected by the installation of the speaker module 200.

In light of the above, the frame of speaker module, the speaker module therewith, and the electronic device with the speaker module of the present invention uses the extending wall of the frame of the speaker module to form a resonance space and adds a front cover and a rear cover to make sure that the space will not be occupied by the other elements. Hence, the speaker module can keep a sufficient resonance space by installing the microspeaker in the speaker module frame first and then installing the front cover and the rear cover in the electronic device. Hence, the present invention can provide a better sound quality than the prior art and can be still compact.

The above description provides a full and complete description of the preferred embodiments of the present invention. Various modifications, alternate construction, and equivalent may be made by those skilled in the art without changing the scope or spirit of the invention. Accordingly, the above description and illustrations should not be construed as limiting the scope of the invention which is defined by the following claims.

1. A speaker module frame, suitable for disposing a microspeaker therein, comprising:
a main portion having an accommodating hole, said accommodating hole accommodating said microspeaker; and
a extending portion, extending from a side of said main portion to form a fixed resonance space for said microspeaker.

2. The speaker module frame of claim 1, wherein the area of said resonance space is larger than the area said microspeaker.

3. The speaker module frame of claim 1, wherein said main portion includes a plurality of positioning slices extending from a sidewall of said accommodating hole to a center of said accommodating hole for positioning said microspeaker.

4. The speaker module frame of claim 1, wherein said microspeaker includes a speaker vibration system and a magnetic loop.

5. The speaker module frame of claim 4, wherein said speaker vibration system is a vibration film having a coil.

6. A speaker module, suitable for a handheld electronic device, comprising:
a speaker module frame, having an accommodating hole;
a microspeaker, accommodated in said accommodating hole;
a front cover, disposed at a first side of said speaker module frame, a front sound enclosure being formed between said front cover and said speaker module frame, said front cover having a plurality of tone holes; and
a rear cover, disposed at a second side of said speaker module frame, said second side being opposite to said first side, a rear sound enclosure being formed between said rear cover and said speaker module frame.

7. The speaker module of claim 6, wherein the area of said speaker module frame facing said front sound enclosure is larger than the area of said microspeaker.

8. The speaker module of claim 6, wherein said speaker module frame includes a plurality of positioning slices extending from a sidewall of said accommodating hole to a center of said accommodating hole for positioning said microspeaker.

9. The speaker module of claim 6, wherein said microspeaker includes a speaker vibration system and a magnetic loop.

10. The speaker module of claim 9, wherein said speaker vibration system is a vibration film having a coil.

11. An electronic device at least comprising a speaker module, said speaker module including
a speaker module frame, having an accommodating hole;
a microspeaker, accommodated in said accommodating hole;
a front cover, disposed at a first side of said speaker module frame, a front sound enclosure being formed between said front cover and said speaker module frame, said front cover having a plurality of tone holes; and
a rear cover, disposed at a second side of said speaker module frame, said second side being opposite to said first side, a rear sound enclosure being formed between said rear cover and said speaker module frame.

12. The electronic device of claim 11, wherein the area of said speaker module frame facing said front sound enclosure is larger than the area of said microspeaker.

13. The electronic device of claim 11, wherein said speaker module frame includes a plurality of positioning slices extending from a sidewall of said accommodating hole to a center of said accommodating hole for positioning said microspeaker.

14. The electronic device of claim 11, wherein said microspeaker includes a speaker vibration system and a magnetic loop.

15. The electronic device of claim 14, wherein said speaker vibration system is a vibration film having a coil.
